(19) United States
(12) Patent Application Publication
(10) Pub. No.: US 2006/0256988 A1
(43) Pub. Date: Nov. 16, 2006

(54) [SOUND-RECORDING/PLAYBACK MEMO CLIP]

(75) Inventor: Wei-Hsin Fang, TAIPEI (TW)

Correspondence Address: ULTMOST INDUSTRIAL CORP., P.O. BOX 108-00403, TAIPEI, TW

(73) Assignee: ULTMOST INDUSTRIAL CORP., Taipei (TW)

(21) Appl. No.: 10/908,510

(22) Filed: May 16, 2005

(51) Int. Cl. H04R 25/00

(52) U.S. Cl. 381/322

(57) ABSTRACT

A sound-recording/playback memo clip is disclosed to include a control unit, which has a housing provided with buttons and accommodating a battery cell and a circuit board controllable by the buttons for sound recording/voice signal playback controls, and a voice pickup/output unit, which has a plate member fixedly connected to one side of the housing and said plate member having an opening, and electro-acoustic device fastened to said opening and electrically connected to said circuit board and controllable by said buttons through said circuit board for picking up sounds/outputting voice signals.

### BACKGROUND OF THE INVENTION

1. Field of the Invention

The present invention relates to a memo clip and more particularly, to such a sound-recording/playback memo clip, which uses one single electro-acoustic device for recording sounds and playback voice signals.

2. Description of the Related Art

In our daily life, we may use memos and a pen/pencil for recording things to help the memory. It is inconvenient to recording things on a memo by a pen/pencil with one hand when talking to a person at a remote place over a telephone and holding the handset of the telephone with the other hand. Further, people may put memos together with invoices, business cards, brochures, and/or other sheet members in the pocket or suitcase. It may take a lot of time to pick up a memo from a number of sheet members.

Further, various electronic products for recording/playing back sounds such as tape recorders, recorder pens, etc. are commercially available. These electronic products commonly use a microphone to pick up sounds and a speaker to output sounds. Because of the complicated microphone and speaker circuit, the conventional electronic sound recording/playback products are expensive and cannot be made very compact.

### SUMMARY OF THE INVENTION

The present invention has been accomplished under the circumstances in view. It is therefore the main object of the present invention to provide a sound-recording/playback memo clip, which uses one single paper-thin electro-acoustic device for recording sounds and playback voice signals. It is another object of the present invention to provide a sound-recording/playback memo clip, which is practical for use in a greeting card, keyring, or memorandum. To achieve these and other objects of the present invention, the sound-recording/playback memo clip is comprised of a control unit and a voice picking up/output unit. The control unit comprises a housing, a battery cell mounted inside the housing, a circuit board mounted inside the housing and electrically connected to the battery cell, and a plurality of buttons mounted on the outside wall of the housing and electrically connected to the circuit board for sound recording/voice signal playback controls. The voice pickup/output unit comprises a plate member fixedly connected to one side of the housing, and an electro-acoustic device fastened to an opening at the plate member and electrically connected to the circuit board and controllable by the buttons through the circuit board for picking up sounds/outputting voice signals.

### BRIEF DESCRIPTION OF THE DRAWINGS

FIG. 1 is an exploded view of a sound-recording/playback memo clip according to the present invention.

FIG. 2 is a front view of the sound-recording/playback memo clip according to the present invention.

FIG. 3 is a front view of an alternate form of the sound-recording/playback memo clip according to the present invention.

FIG. 4 is a side view of FIG. 3.

### DETAILED DESCRIPTION OF THE PREFERRED EMBODIMENT

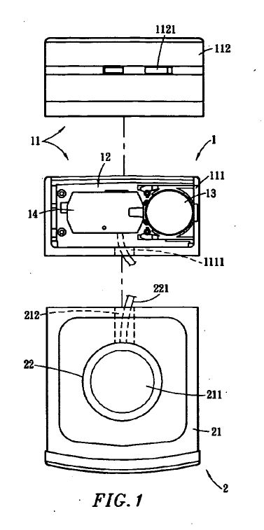

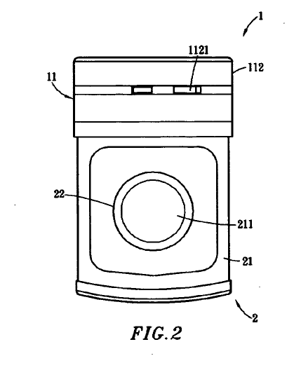

Referring to FIGS. 1 and 2, a sound-recording/playback memo clip in accordance with one embodiment of the present invention is shown comprised of a control unit 1 and a voice pickup/output unit 2.

The control unit 1 comprises a housing 11. The housing 11 comprises a bottom shell 111, and a top cover shell 112 covering the bottom shell 111. The bottom shell 111 has a through hole 1111 at one side. The top cover shell 112 is provided with a plurality of buttons 1121. The bottom shell 111 defines an accommodating space 12, which accommodates a battery cell 13 and a circuit board 14. The buttons 1121 and the battery cell 13 are respectively electrically connected to the circuit board 14.

The voice pickup/output unit 2 comprises a plate member, for example, pearl panel 21, which has an opening 211 and a hole 212 perpendicularly extending from the opening 211 to one peripheral side thereof, an electro-acoustic device 22 fastened to the opening 211 of the pearl panel 21, and an electric wire 221 electrically connected to the electro-acoustic device 22 and extending through the hole 212 to the outside of the pearl panel 21.

Further, the aforesaid circuit board 14 comprises a recording/playback circuit and PWM (pulse width modulation) amplifier circuit assembly (not shown) for controlling the electro-acoustic device 22 to record and playback sounds.

The assembly process of the memo clip is outlined hereinafter with reference to FIGS. 1 and 2 again. Aim the hole 212 of the pearl panel 21 at the through hole 1111 of the bottom shell 111 for enabling the electric wire 221 to be inserted into the through hole 1111 and electrically connected to the circuit board 14, and then fixedly fasten the respective peripheral side of the pearl panel 21 to the bottom shell 111 of the housing 11, and then close the top cover shell 112 on the bottom shell 111 and fixedly fasten the top cover shell 112 and the bottom shell 111 together with fastening elements (not shown).

When in use, the user can operate the buttons 1121 at the top cover shell 112 to drive the circuit board 14, causing the circuit board 14 to control the electro-acoustic device 22 to record sounds or playback recorded voice signals through memory means at the circuit board 14.

The memo clip uses a single electro-acoustic device 22 for picking up sounds and outputting sounds. The whole structure of the memo clip is simple and inexpensive to manufacture, practical for use in a greeting card, keyring, or memorandum.

Further, the electro-acoustic device 22 can be fixedly fastened to the opening 211 with a double-sided adhesive tape or glue. Further, the electro-acoustic device 22 can be a speaker or buzzer.

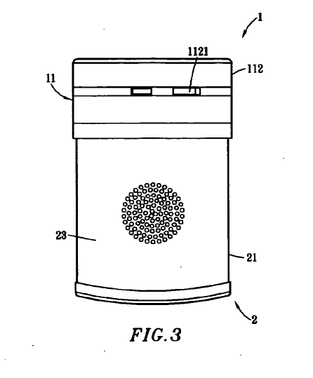

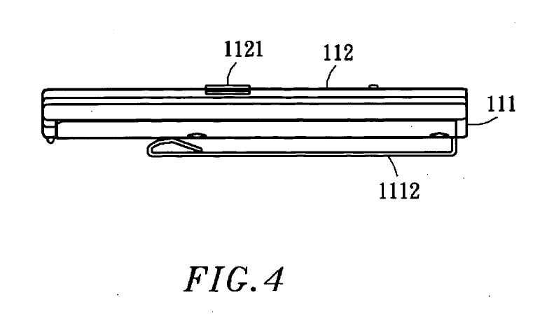

FIGS. 3 and 4 show an alternate form of the sound-recording/playback memo clip according to the present invention. According to this embodiment, the plate member (pearl panel) 21 is decorated with ornamental cover layer 23, which is fixedly fastened to the plate member (pearl panel) 21 by fastening means, for example, glue, screws, etc., and printed with pictures. Further, the bottom shell 111 of the housing 11 is provided with a clip 1112 for clamping paper sheets or for fastening the memo clip to a whiteboard, wall, or any of a variety of support means.

A prototype of sound-recording/playback memo clip has been constructed with the features of FIGS. 1˜4. The sound-recording/playback memo clip functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A sound-recording/playback memo clip comprising:
a control unit, said control unit comprising a housing, a battery cell mounted inside said housing, a circuit board mounted inside said housing and electrically connected to said battery cell, and a plurality of buttons mounted on an outer surface of said housing and electrically connected to said circuit board for sound recording/voice signal playback controls; and
a voice pickup/output unit, said voice pickup/output unit comprising a plate member fixedly connected to one side of said housing, said plate member having an opening, and an electro-acoustic device fastened to said opening and electrically connected to said circuit board and controllable by said buttons through said circuit board for picking up sounds/outputting voice signals.

2. The sound-recording/playback memo clip as claimed in claim 1, wherein said housing comprises a bottom shell and a top cover shell covering said bottom shell.

3. The sound-recording/playback memo clip as claimed in claim 1, wherein said housing has an outside wall provided with a clip for fastening.

4. The sound-recording/playback memo clip as claimed in claim 1, wherein said plate member has a hole extending from said opening to the border thereof; said electro-acoustic device comprises an electric wire inserted through the hole of said plate member and electrically connected to said circuit board.

5. The sound-recording/playback memo clip as claimed in claim 1, wherein said plate member has a layer of ornamental means respectively covered on each of two opposite sidewalls thereof and fixedly secured thereto by fastening means.

6. The sound-recording/playback memo clip as claimed in claim 5, wherein said fastening means is a glue.

7. The sound-recording/playback memo clip as claimed in claim 5, wherein said fastening means is comprised of a plurality of screws.

8. The sound-recording/playback memo clip as claimed in claim 1, wherein said plate member is a pearl panel.

9. The sound-recording/playback memo clip as claimed in claim 1, wherein said electro-acoustic device is fastened to the opening of said plate member with a double-sided adhesive tape.

10. The sound-recording/playback memo clip as claimed in claim 1, wherein said electro-acoustic device is fastened to the opening of said plate member with a glue.

11. The sound-recording/playback memo clip as claimed in claim 1, wherein said electro-acoustic device is a speaker.

12. The sound-recording/playback memo clip as claimed in claim 1, wherein said electro-acoustic device is a buzzer.
